(19) United States
(12) Patent Application Publication
(10) Pub. No.: US 2015/0217480 A1
(43) Pub. Date: Aug. 6, 2015

(54) MIXER VEHICLE, DRIVE TRAIN, CONTROL UNIT AND METHOD FOR OPERATING A MIXER VEHICLE

(71) Applicant: MULDER EUROPE B.V., Dordrecht (NL)

(72) Inventors: Jacobus Antonius Maria van der Wel, LA Dordrecht (NL); Gerbrand August Wynand van Aalst, LA Dordrecht (NL)

(21) Appl. No.: 14/434,575

(22) PCT Filed: Oct. 11, 2013
(86) PCT No.: PCT/NL2013/050726

§ 371 Date: Apr. 9, 2015

(30) Foreign Application Priority Data
Oct. 11, 2012 (EP) 12188178.3

(51) Int. Cl. B28C 5/42; B60R 16/033; B60P 3/16

(52) U.S. Cl. CPC B28C 5/4206; B60P 3/16; B28C 5/4272; B60R 16/033

(57) ABSTRACT

The invention relates to a mixer vehicle (1). Such mixer vehicle (1) can for instance be a concrete mixer truck (1a). The mixer vehicle (1) comprises a mixer drum (3). Further, the mixer vehicle (1) comprises a drive train (4) for driving said mixer drum (3). The drive train (4) comprises an electric motor (5) and a mains connector (6) for connecting the electric motor (5) to a power mains (7). Consequently, the power mains (7) can be used for driving the mixer drum (3), for instance when loading the mixer drum at a concrete batching plant and/or when unloading the mixer drum at a construction site. Besides, the drive train (4) comprises at least one of a generator (8) for generating electric power and a battery pack (9).

The invention relates to a mixer vehicle comprising a mixer drum and a drive train for driving the mixer drum.

Mixer vehicles, such as but not limited to mixer trucks are often used for transporting mixable and/or mixed loads, such as but not limited to concrete or mortar. Normally, the mixer drum is a rotatable drum of which an inside can be provided with a spiral blade. Said spiral blade is arranged to push a load, for instance concrete, further into the drum when the drum rotates in a first rotational direction, and to force the load partly or completely out of the drum when the drum rotates in an opposite, second rotational direction. Normally, between loading and unloading, for instance during transport of the load from a loading site to an unloading site, the drum is rotating, preferably in the first rotational direction. For example, between loading and unloading the drum may rotate at least part of the time in order to mix yet non-mixed or not enough mixed load and/or in order to agitate the load.

Generally, the rotation of the mixer drum is around a longitudinal axis of the drum. Usually, said rotation is powered by a main engine of the mixer truck, an auxiliary (combustion) engine placed on a trailer or semi-trailer, or a main engine of a tractor unit connected to a mixer trailer or semi-trailer, for instance via a power take-off (PTO) connected to the main engine. For example, the PTO may drive a variable type hydraulic pump which can drive a hydraulic motor, wherein the hydraulic motor can be connected to the mixer drum via a reduction box.

Typically, a concrete mixer vehicle is loaded at a concrete plant or so-called batching plant and is subsequently driven to an unloading site such as a construction site. At the unloading site, the concrete mixer vehicle can be unloaded. Often, between loading and unloading, the vehicle is at a stop, for instance when the vehicle is waiting for a traffic light or for its turn to get unloaded at the construction site. Normally, when the vehicle is at a stop, the main engine of the truck or tractor unit keeps running to provide power to the PTO in order to enable rotation of the mixer drum. It is noted that said main engine can make lots of noise, which can be highly unwanted, especially at inhabited areas. Besides, the main engine, normally a combustion engine, emits exhaust gasses during use which are not only unhealthy but may also be subjected to regulation, legislation and/or standardisation such as the EURO 5 norm or the future EURO 6 norm.

It is noted that the disadvantage of the main engine making noise and emitting exhaust gasses does not only occur when the vehicle is waiting. Actually, during loading and unloading, typically the main engine is running at more revolutions per minute than during waiting and/or during transport, because the mixer drum needs more power to push the load in an inward or outward direction, respectively. This can be disadvantageous, for instance because the loading of concrete often occurs in a substantially closed space where the exhaust gasses can hardly get away and/or because of noise pollution due to the main engine running, especially when running at high speed, which lack of sufficient communication even could cause dangerous situations. Moreover, the noise can be hazardous to people.

Further, when a mixer drum is being rotated by the main engine of the mixer truck using a PTO, said main engine cannot be switched off during a stop of the truck. A disadvantage hereof is that, when using the PTO for rotating the mixer drum, the truck cannot use a so-called start-stop system that can automatically shut down and restart the main engine in order to reduce fuel consumption and emissions.

In the past, concrete mixer vehicles having a main engine and an electric motor for driving a mixer drum connected to a battery pack have been proposed. However, in order to use the battery pack to provide enough power for loading and/or unloading the mixer drum, such proposed vehicles need extremely bulky and heavy battery packs which battery packs also are relatively expensive. Further, mixer vehicles have been proposed wherein the main engine of the vehicle can be used temporarily to rotate the mixer drum, for instance during loading or unloading, in stead of the battery pack which for example is used between loading and unloading. However, use of the main engine, especially when it is running at relatively high revolutions, is very disadvantageous, for instance for reasons described above such as noise and emissions.

An object of the present disclosure is to provide an alternative mixer vehicle. It is an object of the present invention to alleviate or solve at least one of the disadvantages above. In particular, the invention aims at providing a mixer vehicle, wherein at least one of the disadvantages mentioned above is counteracted or advantages there above are obtained. More in particular, the invention aims at providing a mixer vehicle, wherein exhaust emissions and/or noises are counteracted, especially during loading and/or unloading of the vehicle's mixer drum. In embodiments, the invention aims at providing a mixer vehicle which enables the use of a start-stop system.

In a first aspect of the disclosure, the present disclosure provides for a mixer vehicle comprising a mixer drum and a drive train for driving the mixer drum, wherein the drive train comprises an electric motor and a mains connector for connecting the electric motor to a power mains, and wherein the drive train further comprises at least one of a generator for generating electric power; and a battery pack.

By providing the mains connector, the electric motor can be connected to a power mains, for instance when the mixer vehicle is at rest during loading, waiting at an unloading site such as a construction site and/or unloading, while the electric engine for rotating the mixer drum can be driven by the power from the mains, which can in embodiments be fed to the engine substantially directly, that is without being stored in a battery pack first or through a generator. The electric motor comprised in the drive train for driving the mixer drum can thus be provided with power from the power mains, at least temporarily. Therefore, for instance during loading, during waiting at an unloading site and/or during unloading, the main engine may be shut off. As a result, the mixer vehicle can thus reduce exhaust emissions and/or noises, while the drum can still be rotated, even at relatively high revolutions, such as for instance at about 10-15 revolutions per minute.

By additionally providing at least one of a generator for generating electric power; and a battery pack, the electric motor for driving the mixer drum can be powered by the generator and/or the battery pack. Consequently, the mixer drum can be rotated by the electric motor even when the mains connector is not connected to a power mains, such as for instance during transport from a concrete batching plant to an unloading site, independent from the main engine.

The invention further relates to a drive train.

Furthermore, the invention relates to a control unit.

The invention also relates to a method for operating a mixer vehicle.

Advantageous embodiments of the invention are described below and in the appended claims

By way of non-limiting examples only, embodiments of the present invention will now be described with reference to the accompanying figures in which:

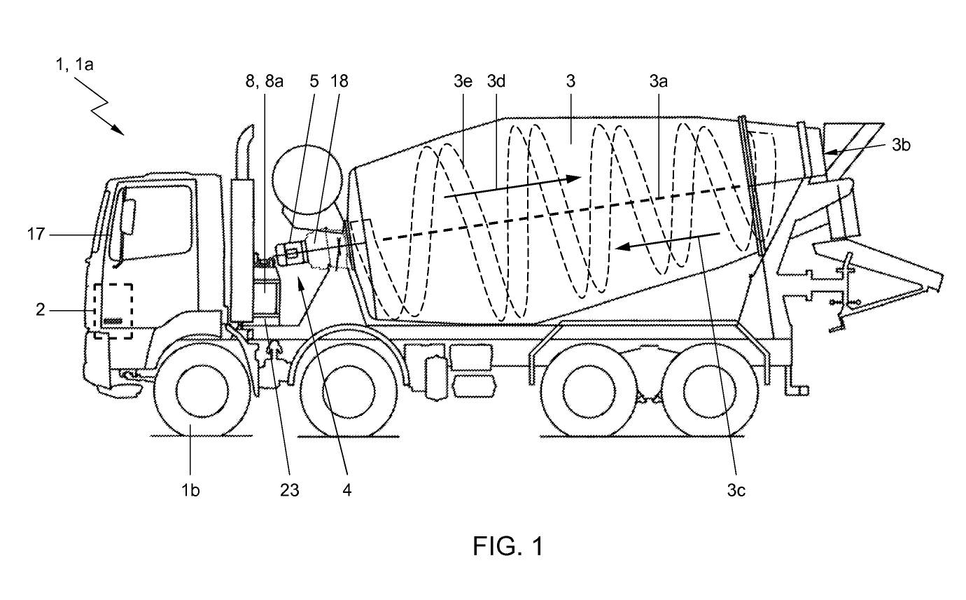

FIG. 1 shows a schematic view of an embodiment of a mixer vehicle according to an aspect of the invention;

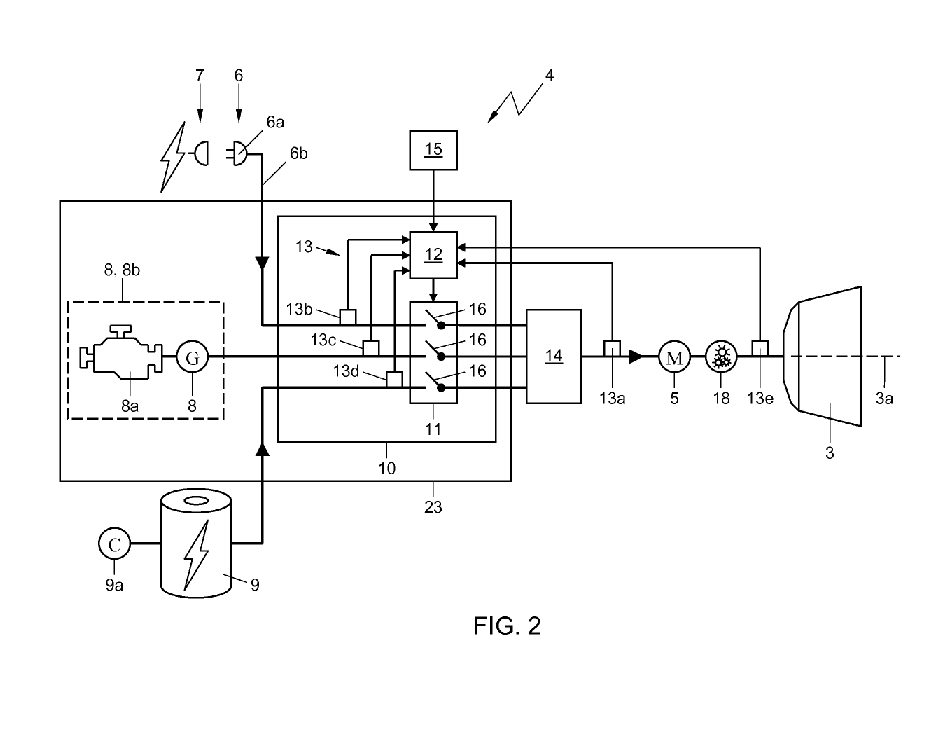

FIG. 2 shows a schematic view of a drive train of the vehicle of FIG. 1; and

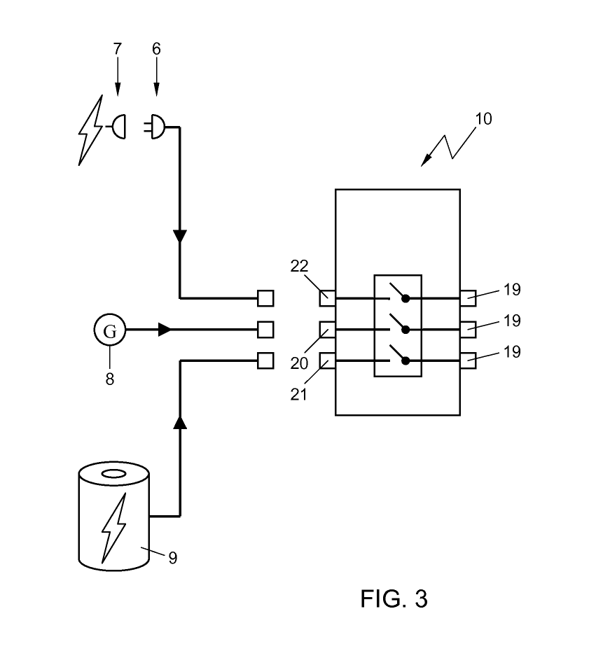

FIG. 3 shows a schematic view of a control unit according to an aspect of the invention.

The embodiments disclosed herein are shown as examples only and should by no means be understood as limiting the scope of the claimed invention in any way. In this description the same or similar elements have the same or similar reference signs.

In general terms, the invention can be understood as being at least directed to a mixer vehicle of which an electric motor for driving its mixer drum can be connected to a power mains during loading, waiting and/or unloading, wherein said electric motor for driving the mixer drum is not used for moving the mixer vehicle. Actually, moving the mixer vehicle may be executed using a separate main engine, such as by a main engine of the mixer vehicle. In this description a mixer vehicle is to be understood at least as a vehicle for mixing or agitating content in a mixer drum and transporting said content from a loading position to an unloading position. A mains or power mains has to be understood as a connection or connection point or element of a power grid such as but not necessarily limited to a public or private power grid connected to an electric power plant, providing for example 3 phase electric power and/or power of for instance 220 or 380-480 Volts or any such normally used voltage on a power grid.

FIG. 1 shows a schematic view of an embodiment of a mixer vehicle 1. Here, the mixer vehicle 1 is a mixer truck 1a having a main engine 2 for moving said truck 1a, for example by driving wheels 1b of the truck 1a. Alternatively, the mixer vehicle 1 can for instance comprise a tractor unit and a mixer trailer or mixer semi-trailer. Said tractor unit can have a main engine 2 for moving said tractor unit and/or a connected trailer or semi-trailer. The tractor unit and the trailer or semi-trailer may be arranged for connection to each other. It is noted that the main engine 2 of the mixer vehicle 1 can for example be a combustion engine.

The mixer vehicle 1 of FIG. 1 comprises a mixer drum 3 and a drive train 4 for driving said mixer drum 3. Preferably, the mixer drum 3 is drivable around a longitudinal axis 3a of said drum 3. The mixer drum 3 can comprise an opening 3b for loading and unloading the mixer drum 3. Further, the mixer drum 3 may be provided with a means for moving load in an inward direction 3c and/or an outward direction 3d. Here, for instance, an inside of the mixer drum 3 is provided with a spiral blade 3e fixed to said inside and arranged for pushing a load in the inward direction 3c when the mixer drum 3 rotates in a first rotational direction, for pushing the load in the outward direction 3d when the mixer drum 3 rotates in a second rotational direction opposite to the first rotational direction, and/or for mixing a load when the drum 3 rotates at a relatively low speed such as but not limited to a speed of about 1-3 or about 1.5-2 revolutions per minute, preferably in the first rotational direction. The mixer drum 3 may be conventional.

FIG. 2 shows a schematic view of the drive train 4 of the vehicle 1 shown in FIG. 1. The drive train 4 comprises an electric motor 5 and a mains connector 6 for connecting the electric motor 5 to a power mains 7. The electric motor 5 is for driving the mixer drum 3, preferably around its longitudinal axis 3a. Thereto, the electric motor 5, for example by means of an outgoing axis of said motor 5, may be connected to the mixer drum 3, for instance via a reduction box 18. The mains connector 6 may for instance comprise or consist of a plug 6a or a power cable 6b and a thereto connected plug 6a. Preferably, the power cable 6b is a flexible power cable. Here, the drive train 4 further comprises a generator 8 for generating electric power and a battery pack 9. It is noted however, that in embodiments the drive train 4 does not need to, but nevertheless may, comprise both a generator 8 and a battery pack 9. This is, the drive train 4 can comprise at least one of a generator 8 for generating electric power; and a battery pack 9. For example, the drive train 4 can comprise a battery pack 9, but no generator 8. Alternatively, the drive train 4 can for instance lack a battery pack 9, but can comprise a generator 8.

The generator 8 or so called electric generator 8 may comprise and/or may be connected to a generator engine 8a. The generator engine 8a can be a piston engine, such as but not limited to a combustion engine for example running on diesel, petrol and/or gas. Alternatively or additionally, the generator 8 can for instance comprise at least one gas turbine and/or other means for providing the generator 8 with a source of mechanical energy 8a. In embodiments, the generator 8 is an engine-generator 8b comprising a generator engine 8a.

By providing the generator engine 8a, the generator 8 can be provided with a source of energy 8a, even when the main engine 2 for driving the truck 1a or tractor unit is shut off. Since the main engine 2 is not needed for driving the mixer drum 3 during loading, waiting and/or unloading said mixer drum 3, exhaust emissions and/or noises can be reduced significantly. Besides, due to that the generator engine 8a can be a relatively small, silent and/or clean engine 8a compared to the main engine 2, exhaust emissions and/or noises can be reduced significantly during loading, waiting and/or unloading in comparison to using the main engine 2 for driving the mixer drum 3.

By providing the battery pack 9 for providing electric power and by arranging the drive train 4 to provide the electric power from the battery pack 9 to the electric motor 5, the mixer drum 3 can be rotated without running the main engine 2. Consequently, noise and/or emissions can be counteracted.

An advantage of providing both the electric generator 8 and the battery pack 9 is for example that the battery pack 9 can be used when only a relatively low level of emissions and/or noise level is wanted or permitted, for instance when driving down town. However, the capacity of the battery pack 9 can be limited, because the generator 8 may in embodiments function as a backup power source and/or as an alternative power source, which may for instance be used to save the battery pack, such as for example when driving in the country site. When using the generator 8 as power source, the battery pack 9 may serve as a backup power source, for instance because the generator engine 8a can run out of fuel. It is noted that a backup power source can be very advantageous, for instance because it is highly unwanted that concrete sets inside a mixer drum 3 due to a not rotating mixer drum.

In embodiments, the vehicle 1 is provided with charger 9a for charging the battery pack 9. The charger 9a may for instance be connected with or connectable to the electric generator 8, 8b. Alternatively or additionally, the charger 9a may be connected with or connectable to the main engine 2 of the truck 1a or tractor unit, for instance via a board network of said truck 1a or tractor unit. Further, alternatively or additionally, the charger 9a may be connectable to a power mains, for instance by means of the mains connector 6 and/or by means of a separate, second mains connector. In an embodiment the charger can be connected selectively to one or two or three of these alternative sources, so as to allow an appropriate selection, manually and/or automatically. It is noted that, alternatively or additionally, other means may be used to provide the charger 9a with power. For example, the mixer vehicle 1 may be provided with solar panels and/or a separate, not shown, electric generator and/or the charger 9a may be connected to and/or connectable with a PTO of the vehicle.

Alternatively or additionally, the battery pack 9 may be replaceable. An empty or low battery pack 9 may then be replaced by a full or at least fuller battery pack.

In the shown embodiment, the drive train 4 comprises a switch system 11 for connecting the electric motor 5 selectively with the mains connector 6, the generator 8 and/or the battery pack 9. In embodiments, the switch system 11 can thereto comprise one or more switches 16 for making or ending one or more respective connections. By providing the switch system 11, the source of the power supply to the electric motor 5 can be selected. For instance, the electric motor 5 can be provided selectively with power from the battery pack 9 and/or the electric generator 8, for instance while the mixer vehicle 1 is on the road, and the electric motor 5 can be provided with power from the mains connector 6, for instance when said mains connector 6 is connected to the mains 7, for instance during loading, waiting at a delivery site and/or unloading.

In embodiments, the switch system 11 allows connecting the electric motor 5 selectively with at least two, preferably all three, of the mains connector 6, the generator 8 and the battery pack 9 at the same time. By connecting said motor 5 to at least two or at least three sources of electric energy 6, 8, 9 at the same time, the electric motor 5 can for instance be provided with more power. When one source of electric energy 6, 8, 9, for instance the mains connector 6 connected to the mains, cannot supply enough electric power, another one of the sources of electric energy 6, 8, 9, such as the battery pack 9 and/or the generator 8, can supply additional electric power. This may be advantageous, for example when during loading or unloading the mixer drum 3 is rotated with a relatively high rotational speed such as but not limited to a speed of about 8-16, about 10-15 or about 12 revolutions per minute and/or during speeding up said drum 3 and/or prior to unloading, when the speed is already sped up to a speed of for instance about 4, 5, 6 or 7 revolutions per minute.

In the shown embodiment, the drive train 4 comprises a controller 12, for instance a programmable logic controller. The controller 12 is at least arranged for at least partly controlling the switch system 11. For example, the controller 12 can provide current or voltage to the switch system 11 and/or to at least one of the switches 16, which switch 16 may be a relay such as for instance a relay operable by an electromagnet.

Here, the drive train 4 comprises a sensor system 13 which may be arranged for sensing a power need of the electric motor 5 and/or a power consumption of said motor 5. Alternatively or additionally, the sensor system 13 can be arranged for sensing availability of power via the mains connector 6, from the generator 8 and/or from the battery pack 9. The sensor system 13 can comprise one or more sensors 13a-13e or so-called detectors 13a-13e for sensing a power need or power consumption of the electric motor 5. For instance, said sensor system 13 can comprise a motor sensor 13a for sensing a power need of the electric motor 5. The motor sensor 13a is here provided at a power supply cable for supplying power to the electric motor 5 and is arranged for detecting the power supply to the motor by sensing an amperage, but alternatively or additionally a motor sensor 13a may be placed at another position. For example, an alternative motor sensor 13a may be located at the motor, and it may for instance be arranged for sensing the power consumption of the motor and/or its rotation speed. Additionally or alternatively, the sensor system 13 can comprise one or more sensors 13b, 13c, 13d for sensing availability of power via the mains connector 6, from the generator 8 and/or from the battery pack 9. Alternatively or additionally, other sensors or detectors 13 may be provided. For example, a sensor may be provided for sensing the fuel level of a not shown fuel tank connected to the generator engine 8a. As another example, a sensor 13e may be provided for sensing the rotation speed and/or direction of rotation of the mixer drum 3 and/or a drive shaft for driving said drum 3.

In an embodiment, one or more mains connection sensors can be provided for sensing whether or not the mains connector 6 is connected to a power mains 7. For example, said sensor or one of said sensors may be arranged to detect current and/or voltage, especially in a power cable 6b of the mains connector 6. Alternatively or additionally, said mains connection sensor or one of said sensors may be arranged for sensing whether or not a plug 6a of the mains connector 6 is physically plugged into a power mains 7. The data provided by said one or more sensors may be used at least partly by the controller 12 for controlling the switch system 11. Additionally or alternatively, said data may be provided to a second controller, which can be part of a power management unit of the truck 1a or tractor unit. Said second controller may be provided in the truck 1a or tractor unit, and may be arranged for counteracting temporarily that said truck 1a or tractor unit can drive off, for instance by controlling a lock for prevented that a parking brake or hand brake of the truck 1a or tractor unit is released, and/or by controlling a means, e.g. a start interrupter, for preventing that the main engine 2 can be started.

Alternatively or additionally, a truck 1a or tractor unit may be provided with a brake sensor for sensing whether or not its parking brake or hand brake is engaged. Preferably, said brake sensor can be connected with the controller 12 and said controller 12 may be arranged for controlling the drum 3, especially its rotational speed, based at least partly on data provided for by said brake sensor. Alternatively, the brake sensor may be connected to a further controller arranged for controlling the drum 3 and/or the electric motor 5. For instance, when is detected that the parking brake is not engaged, the controller 12 or said further controller may assume that the mixer vehicle 1 is driving or will start driving soon, and may control drum, for instance by slowing down a relatively fast rotating drum to a predetermined relatively low rotational speed, for instance a speed of 1-3, especially about 2 or about 3, rotations per minute. Alternatively or additionally, the mixer vehicle 1 may be provided with a speed sensor for sensing the driving speed of said vehicle 1, wherein the speed sensor is connected to the controller 12 or a further controller, and the respective controller is arranged for controlling the rotational speed of the drum 3 based at least partly on a driving speed sensed by said speed sensor. Controlling the rotational speed of the drum 3, especially when the mixer vehicle 1 is driving, may counteract wear and may extend the life time of the vehicle 1, especially the life of its electric motor 5.

Additionally or alternatively, a slope sensor may be provided, for instance an angular position sensor, for sensing uphill and/or downhill driving. Said sensor may be connected to the controller 12 or the further controller, which may be arranged to control that the drum 3 based on data provided by said sensor. As a result, when is detected that the vehicle 1 is driving uphill or downhill at an angle larger than a predetermined threshold angle, the respective controller can control the mixing drum 3, thereby enabling that the drum 3 speeds up or slows down. For example load tending to move in the backward direction 3d when driving uphill, may be then forced in the inward direction 3c relatively well due to speeding up the drum 3, thereby counteracting unintentional loss of load.

It is noted that one or more of the above described sensors, e.g. the mains connection sensor, the brake sensor, the speed sensor, and/or the slope sensor, can also be applied in other vehicles, especially mixer vehicles. In principle, one more of said sensors can be applied in any mixer vehicle comprising a mixer drum and a drive train for driving the mixer drum, wherein the drive train comprises an electric motor for driving the mixer drum and a controller for controlling the electric motor, wherein the controller is connected to the respective sensor, and wherein said controller is arranged for controlling the drum at least partly based on data provided by said respective sensor.

Here, i.e. in the embodiment shown in FIGS. 1-3, the sensor system 13 is connected to the controller 12 and said controller 12 is arranged for setting the switch system 11 at least partly based on said detected power need or consumption and/or said detected availability of power. The switch system 11 may for instance be arranged to connect the electric motor 5 to the mains connector 6, for example when the electric motor 5 needs a relatively high power supply, such as for example during loading and/or unloading. Further, the switch system 11 may be arranged for additionally connecting the electric motor 5 to an additional electric power source 8, 9, for example when is sensed that the mains connector 6 cannot supply enough power in order to meet a predefined minimum power threshold for a certain task such as loading and/or unloading and/or in order to meet an actual power need, such as for instance is sensed by the motor sensor 13a. Alternatively or additionally, the switch system 11 may be arranged to connect the electric motor 5 to the battery pack 9 and/or to the generator 8, for example when it is sensed that the mains connector 6 is not connected to the mains. Preferably, the switch system 11 and/or a respective switch 16 is arranged to disconnect one or more of the sources of electric energy 6, 8, 9, for example when it is sensed that the electric power supply of a respective source of electric energy 6, 8, 9 does not meet a predefined minimum power supply level. As a result, it may for instance be counteracted that the battery pack 9 is further drained while said battery pack 9 can already not longer substantially supply the electric motor 5 of enough power.

In the shown embodiment, the drive train 4 further comprises an electric circuit 14 for driving the electric motor 5 on direct current and/or alternating current power sources 6, 8, 9. For instance, the electric circuit 14 may be arranged to adapt the power supply from direct current to alternating current, such as but not limited to two-phase or three-phase electric power, and/or from alternating current to direct current. Additionally or alternatively, the electric circuit 14 may be arranged for combining at least a part of the power supplies of two or more power sources 6, 8, 9, preferably, if so desired, after the electric circuit 14 has adapted the current supplied by the respective power source to power of a respective current type needed for the electric motor 5. For example, the electric circuit 14 may be arranged to adapt the direct current and/or the two-phase electric power into three-phase electric power, for instance when the electric motor is running on three-phase electric power, and the power mains connector 6 supplies two-phase electric power and the battery pack 9 supplies direct current power. In embodiments, the electric circuit 14 can comprise a frequency changer or a so-called frequency converter.

In embodiments, the drive train 4 can be provided with an input device 15 for inputting data concerning an intended drive state of the mixer drum 3. The input device 15 may for instance be arranged for allowing an operator of the mixer vehicle 1 to input data concerning an intended drive state of the mixer drum 3, such as but not limited to a multiple position rotary selector knob. The intended drive state can for instance be a loading state, an unloading state, a mixing state wherein yet unmixed and/or not fully mixed load is mixed, an agitating state or an off state wherein the mixer drum is at a stop. Preferably, the input device 15 is connected to the controller 12. Alternatively or additionally, the input device 15 may be connected to the electric motor 5. The controller 12 may be arranged for controlling the switch system 11 at least partly based on inputted data.

By inputting the intended drive state, the electric motor 5 may be set to an intended driving condition and/or the switch system 11 can be brought into a corresponding switch state. As mentioned above, the operator, such as but not limited to a driver of the mixer vehicle, may input the data concerning an intended drive state into the input device 15. For example, the operator may input that loading or unloading of the mixer drum 3 should start or stop right now. Thereto, the input device 15 may for instance comprise one or more stop and start buttons or a stop/start button. Alternatively or additionally, the input data can for instance comprise a starting time when a certain drive state should start and/or an ending when it should stop and/or a time interval for how long a certain drive state should continue. Thereto, the input device 15 may for example comprise an internal clock, a timer and/or a counter and corresponding input means. Besides, the input data may comprise conditions for starting, continuing, pausing, restarting and/or ending a certain drive state. Such conditions may comprise for instance a maximum or/and a minimum level of power consumption of the electric motor, for instance a power consumption level corresponding to driving the mixer drum at a certain rotational speed when said drum holds a certain amount of load.

Alternatively or additionally, the input device 15 or an additional input device of the drive train 4 may be arranged for inputting data concerning preferable power source use. As a result, an operator can for instance input data about which power source or power sources should be given priority by the controller 12.

Further, the controller 12 can be arranged for setting the switch system 11 at least partly based on inputted data. The controller 12 may for instance comprise a computer or microprocessor for controlling the switch system 11, for instance at least partly based on inputted data. For example, when the inputted data for instance corresponds to a loading or an unloading state, generally corresponding to a relative high power consumption of the electric motor 5, the controller 12 may for instance drive the switch system 11 to connect the mains connector 6 to the electric motor 5.

It is noted that the input device 15, one or more of a multiple number of input devices 15 and/or input means may be arranged for enabling an operator to select a limited number of predefined settings. Such limited number of predefined steps may for instance include one or more of the intended drive states which may include a loading state, an unloading state, a mixing state wherein yet unmixed and/or not fully mixed load is mixed, an agitating state or an off state wherein the mixer drum is at a stop. Additionally or alternatively, the input device 15 may be arranged for enabling the operator to set the rotational speed and/or direction of the mixing drum 3 and/or the running speed of the electric motor 5 in advance of a start of a certain drive state and/or to adjust it during the drive state. For example, the speed of the mixing drum 3 and/or the electric motor 5 may be continuously adjustable or may be inputted in certain predefined increments only. Additionally or alternatively, the input device 15 and/or the controller 12 may be arranged for enabling the operator to select and/or deselect one or multiple of the power sources 6, 8, 9. The operator can then indicate use of which of the power sources 6, 8, 9 is desired at a certain moment. For instance, the operator may choose to save the battery pack 9 and/or the fuel supply for the generator engine 8a and/or may choose not to use the power mains 7 any longer, for example because it is intended to disconnect the mains connector 6 in order to prepare for removing the mixer vehicle 1.

Alternatively or additionally, the input device 15 may be arranged for selecting a predefined drive state of the mixer drum 3, such as but not limited to one or more of the loading state, unloading state, mixing state, agitating state and the off state.

In embodiments, the input device 15 is arranged for selecting one of multiple power source presets. The presets may include a preset for only using the power main 7, a preset for only using the generator 8, a preset for only using the battery pack 9, a preset for using the battery pack and the generator, a preset for using the generator and the power mains 7, a preset for using the power mains and the battery pack and/or a preset for using the power mains 7, the generator 8 and the battery pack 9. In embodiments, the controller 12 may be arranged for selecting one or more of the power sources preselected by the operator. Alternatively or additionally, the controller 12 may be arranged for overruling the selection of the operator and can select a power source not included in the respective preset selected by the operator.

Preferably, the input device 15 is arranged for receiving at least manual input into the device 15. The input device 15 may for instance comprise one or more suitable input means such as but not limited to one or more selector switches, rotary controls, buttons and/or touch screens. It is noted that the input device 15 may for example be provided in or at a cabin 17 of the truck 1a or tractor unit or at a trailer part of the vehicle 1. Alternatively or additionally, the input device 15 may be provided at least partly at another place, for instance, at a housing 23 accommodating at least parts of the drive train 4, or at the back of the mixer vehicle 1, preferably close to a rear discharger. The input device 15 may comprise a smartphone including at least one respective application which can be connected wirelessly with a receiving part of the input device 15. It is noted that, in embodiments, the drive train 4 may be provided with more than one input device 15.

In embodiments, the input device 15 may be provided with an input means comprising a control lever. Preferably, the lever is provided near a chute for guiding unloaded load, preferably provided at the back of the mixer vehicle 1. Advantageously, the lever may resemble a conventional pump control lever such as often is provided at a conventional mixer vehicle for controlling a hydraulic pump in order to drive its mixer drum. As a result, the input device 15 can have the look and/or feel of a conventional mixer vehicle, which may facilitate acceptance of the mixer vehicle 1 and/or simplify operation of the mixer vehicle 1. In embodiments, the lever may have a neutral position, corresponding with a stationary state of the drum 3, and may be movable to two sides, both sides corresponding with a respective rotational direction of the drum 3. Preferably, the input device 15 may be arranged such that the further the lever is moved in a respective direction, the faster the drum will rotate. It is noted that the control lever may for instance be provided with a potentiometer for sensing how far the lever is turned, which potentiometer may be connected to the controller 12 and/or a further controller for controlling the electric motor 5 and/or the drum 3. The control lever may thus be arranged for enabling the operator to set the rotational speed and/or direction of the mixing drum 3 and/or the running speed of the electric motor 5. Preferably, the controller 12 and/or the further controller may be arranged to counteract too rapid acceleration and/or deceleration of the drum 3. For instance, when the lever is moved relatively rapidly by an operator from one position to a new position, thereby inputting that he intends a relatively rapid acceleration or deceleration, the controller 12 and/or the further controller may carry out such command gradually, thereby relatively slowly accelerating or decelerating the drum to the speed corresponding with said new position.

It is noted that the control lever may be provided with a lever lock counteracting accidental turning of said control lever, e.g. when the lever is unintentionally hit by an object or is pushed by a vandal. The lock may for instance comprise a spring applied button, preferably provided on the lever, especially at a distal end of the lever or at back side of the lever facing a part of the mixer vehicle substantially blocking the view on said button. Further, the button may be biased outwardly, wherein its outward position corresponds with a locked state of the control lever, and may be arranged to be pressed inwardly, thereby unlocking the control lever in order to enable controlling the mixer drum.

Additionally or alternatively, the controller 12 may be arranged for controlling the lever lock, preferably at least partly based on data about the state of the hand brake provided by the brake detector. For instance, when is detected that the hand brake is not engaged, the controller 12 and/or the further controller may control the lever lock such that the lever stays locked, at least as long as the hand brake is not engaged. Hence, it can be counteracted that the control lever can be turned accidentally to another position.

It is noted that one or multiple embodiments of the control lever described above may also be applied in other mixer vehicles. In principle, such a control lever can be applied in any mixer vehicle, comprising a mixer drum and a drive train for driving the mixer drum, wherein the drive train comprises an electric motor and a controller for controlling the electric motor, wherein the drive train is provided with an input device for inputting data concerning an intended drive state of the mixer drum, wherein the input device comprises a control lever as described above, wherein said lever and preferably is connected to the controller, and wherein the controller is arranged for controlling the drum at least partly based on data inputted by means of said control lever.

The invention further relates to a drive train 4 for driving a mixer drum 3 of a mixer vehicle 1, such as for example but not limited to the drive train 4 of FIG. 2 comprised in the vehicle 1 of FIG. 1. The drive train 4 comprises an electric motor 5 and a mains connector 6 for connecting the electric motor 5 to a power mains 7. Further, the drive train 4 comprises at least one of a generator 8 for generating electric power and a battery pack 9 for supplying electric power. Additionally, the drive train 4 may be provided with one or more of the features described above in the context of the drive train 4 which is part of the mixer vehicle 1 according to an aspect of the invention.

FIG. 3 shows a schematic view of a control unit 10 according to a further aspect of the invention. The control unit 10 is for a drive train, such as but not limited to one or more of the above described drive trains, for driving a mixer drum of a mixer vehicle, such as but not limited to the mixer vehicle according to an aspect of the invention. In embodiments, the control unit 10 is arranged for coupling to a mains connector 6 of the drive train. For example, the control unit 10 can comprise a coupler 22 coupleable to the mains connector 6 and/or a coupling, such as a fixed coupling to the mains connector 6 which coupling for instance cannot be uncoupled. Further, the control unit 10 can be arranged to an electric motor of the drive train. Thereto, the control unit 10 can comprise one or multiple couplers 19 coupleable to the electric motor or one or multiple couplings to said electric motor. It is noted that the control unit 10 may be coupled to and/or be coupleable to the electric motor via one or more elements placed between the electric motor and the control unit 10, such as but not limited to an electric circuit for driving the electric motor on direct current and/or alternating current power sources. The control unit 10 further is arranged for coupling to a battery pack 9 of the drive train and/or to a generator 8 of the drive train. Thereto, the control unit 10 may comprises a coupler 20 coupleable to and/or a coupling to a generator 8 of the drive train and/or a coupler 21 coupleable to and/or a coupling to a battery pack 9 of the drive train. The control unit 10 further comprises a switch system 11 for connecting an electric motor 5 or at least one of the respective couplers 19 selectively with the mains connector 6, the generator 8 and/or the battery pack 9 and/or with at least one of the respective couplers 22, 20, 21. It is noted that one or more of the couplers 22, 19, 20, 21 may comprise one or multiple suitable coupling elements, such as but not limited to plugs, sockets, screw terminals and/or any conventional electric coupling elements. It is noted that the control unit 10 may additionally comprise one or more of the features described above in the context of the control unit 10 which is included in the drive train 4 being part of the mixer vehicle 1 according to an aspect of the invention. Preferably, the control unit 10 further comprises a controller 12 for controlling the switch system 11. Further, the control unit 10 may comprise one or more sensors coupled to the controller 12 and/or couplers for coupling one or more sensors to the controller 12. It is noted that the control unit 10 can alternatively or additionally comprise one or more other components of the drive train 4. For instance, the control unit 10 may at least partly comprise an electric circuit 14 and/or a frequency charger.

The invention also relates to a method for operating a mixer vehicle 1 having a mixer drum 3. The method comprises the step of connecting at least one mains connector 6 of the mixer vehicle 1 to a power mains 7. For example, the connecting may be executed by plugging in a plug of a mains connector. Alternatively or additionally, the connecting may comprise establishing a wireless energy transfer or wireless electric power connection, such an inductive coupling using conductors. Further, the method comprises feeding electric power from said power mains 7 to an electric motor 5 of the mixer vehicle 1 for driving the mixer drum 3 and driving the mixer drum 3 by means of said electric motor 5. For example, the electric power may be fed from the power mains 7 to the electric motor 5 when loading of the mixer drum 3. Alternatively or additionally, the electric power can be fed from the power mains 7 to the electric motor 5 when unloading of the mixer drum 3. This can be advantageous, because the mixer drum 3 may run at relative high revolutions during loading and/or unloading, for instance at about 10-12 revolutions per minute, whereas the mixer drum 3 may for instance run at about 2 revolutions per minute when it is moving from a loading site toward an unloading site.

The invention is not restricted to the embodiments described above. It will be understood that many variants are possible.

For example, the mixer vehicle 1 may be provided with a detector, for instance a RFID, reader for detecting that the mixer vehicle 1 is at or near a site where a suitable power mains 7 is present and/or available. Said site and/or power mains 7 may for example be provided with a corresponding transmitter, for instance a corresponding RFID chip.

As a further example, the drive train 4, for instance by means of its controller 12, may be provided with a starting device which may prevent that, for instance when starting the electric motor 5 and/or when increasing the rotational speed of the mixer drum 3, a too high peak in power consumption occurs. As a result, it may be counteracted that a connected power mains 7 gets disabled.

Further, the drive train may comprise a housing 23 or casing arranged for sound insulating. Such a sound insulating housing may for instance accommodate parts of the drive train 4, such as but not limited to the generator engine 8a.

These and other embodiments will be apparent to the person skilled in the art and are considered to lie within the scope of the invention as formulated in the following claims.

1. Mixer vehicle, comprising a mixer drum and a drive train for driving the mixer drum, wherein the drive train comprises an electric motor and a mains connector for connecting the electric motor to a power mains, and wherein the drive train further comprises at least one of:
a generator for generating electric power; and
a battery pack.

2. Mixer vehicle according to claim 1, wherein the drive train comprises a switch system for connecting the electric motor selectively with the mains connector, the generator and/or the battery pack.

3. Mixer vehicle according to claim 2, wherein the switch system allows connecting the electric motor selectively with at least two of the mains connector, the generator and the battery pack at the same time.

4. Mixer vehicle according to any one of claim 2 or 3, the drive train further comprises a controller for controlling the switch system.

5. Mixer vehicle according to any one of claims 2-4, wherein the drive train comprises a sensor system for sensing a power need or consumption of the electric motor and/or for sensing availability of power via the mains connector, from the generator and/or from the battery pack, wherein the sensor system is connected to the controller and said controller is arranged for setting the switch system at least partly based on said detected power need or consumption and/or said detected availability of power.

6. Mixer vehicle according to any one of the previous claims, wherein the drive train comprises an electric circuit for driving the electric motor on direct current and/or alternating current power sources.

7. Mixer vehicle according to any one of the previous claims, wherein the drive train is provided with an input device for inputting data concerning an intended drive state of the mixer drum, wherein the input device preferably is connected to the controller or a further controller and the controller or the further controller preferably is arranged for controlling the switch system and/or the mixer drum at least partly based on inputted data.

8. Mixer vehicle according to claim 7, wherein the input device is provided with an input means comprising a control lever.

9. Mixer vehicle according to any one of the previous claims, wherein the vehicle is a mixer truck comprising the drive train with the electric motor and further comprising a main engine for driving said truck, or wherein the vehicle comprises a tractor unit and a mixer trailer or mixer semi-trailer, the tractor unit comprising a main engine for driving the vehicle.

10. Drive train for driving a mixer drum of a mixer vehicle, comprising an electric motor and a mains connector for connecting the electric motor to a power mains, and at least one of:
a generator for generating electric power; and
a battery pack.

11. Control unit for a drive train for driving a mixer drum of a mixer vehicle, arranged for coupling to a mains connector of the drive train and arranged for coupling to an electric motor of the drive train for driving a mixer drum, the control unit further is arranged for coupling to a generator of the drive train and/or a battery pack of the drive train, wherein the control unit further comprises a switch system for connecting an electric motor and/or the respective coupler selectively with the mains connector, the generator and/or the battery pack and/or with the respective coupler.

12. Method for operating a mixer vehicle having a mixer drum, comprising the steps of:
connecting a mains connector of the mixer vehicle to a power mains;
feeding electric power from said power mains to an electric motor of the mixer vehicle for driving the mixer drum; and
driving the mixer drum by means of the electric motor.

13. Method according to claim 12, wherein the electric power is fed from the power mains to the electric motor when loading of the mixer drum.

14. Method according to claim 12, wherein the electric power is fed from the power mains to the electric motor when unloading of the mixer drum.
